(19) United States
(12) Patent Application Publication
(10) Pub. No.: US 2006/0196915 A1
(43) Pub. Date: Sep. 7, 2006

(54) High-power ultrasonic horn

(75) Inventor: Rudolf W. Gunnerman, Reno, NV (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SulphCo, Inc., Sparks, NV (US)

(21) Appl. No.: 11/066,766

(22) Filed: Feb. 24, 2005

(51) Int. Cl. B23K 20/10

(52) U.S. Cl. 228/110.1

(57) ABSTRACT

An ultrasonic horn for use in a chemical reactor is formed as a unitary piece of material whose length is approximately equal to the wavelength of ultrasonic waves through the material at a selected ultrasonic frequency. The horn has a conically shaped distal end and a mounting surface at its proximal end, plus a mounting fixture between the proximal and distal ends for mounting the horn to a flow-through reactor with the distal end protruding into the reactor interior while the proximal end extends outside the reactor. The horn further contains a seal between the proximal and distal ends to seal the horn to the interior of a reaction vessel in a fluid-tight manner. With the unitary construction and the conical distal end, the horn is capable of transmitting high power ultrasonic waves to the reactor interior without damage to the horn or its mounting fixtures.

### BACKGROUND OF THE INVENTION

1. Field of the Invention

This invention resides in the field of process equipment used in the treatment of materials in liquid media by ultrasound.

2. Description of the Prior Art

The use of ultrasound for driving chemical reactions is well known. Examples of publications that describe chemical uses of ultrasound are Suslick, K. S., Science, vol. 247, p. 1439 (1990), and Mason, T. J., Practical Sonochemistry, A User's Guide to Applications in Chemistry and Chemical Engineering, Ellis Norwood Publishers, West Sussex, England (1991). Of the various sonicating systems that have been developed, those known as “probe”-type systems include an ultrasonic transducer that generates ultrasonic energy and transmits that energy to an ultrasonic horn for amplification.

Ultrasound generators are generally of limited energy output due to the power needed to drive the vibrations and the heat generated by ultrasonic transducers. Because of these limitations, the use of ultrasound for large-scale chemical processes has met with limited success. One means of achieving ultrasonic vibrations at a relatively high power is by the use of magnetostriction-driven ultrasound transducers, but frequencies attainable by magnetostriction drives are still only moderate in magnitude. Disclosures of the magnetostriction ultrasound transducers and their use in chemical reactions appear in Ruhman, A. A., et al. U.S. Pat. No. 6,545,060 B1 (issued Apr. 8, 2003), and its PCT counterpart WO 98/22277 (published May 28, 1998), as well as Yamazaki, N., et al. U.S. Pat. No. 5,486,733 (issued Jan. 23, 1996), Kuhn, M. C., et al. U.S. Pat. No. 4,556,467 (issued Dec. 3, 1985), Blomqvist, P., et al. U.S. Pat. No. 5,360,498 (issued Nov. 1, 1994), and Sawyer, H. T., U.S. Pat. No. 4,168,295 (issued Sep. 18, 1979). The Ruhman et al. patent discloses a magnetostriction transducer that produces ultrasonic vibrations in a continuous-flow reactor in which the vibrations are oriented radially relative to the direction of flow and the frequency range is limited to a maximum of 30 kHz. The Yamazaki et al. patent discloses a small-scale ultrasonic horn operating at relatively low power, in which magnetostriction is listed as one of a group of possible vibration-generating sources together with piezoelectric elements and electrostrictive strain elements. The Kuhn et al. patent discloses a continuous-flow processor that includes a multitude of ultrasonic horns and generators supplying frequencies less than 100 kHz. The Blomqvist et al. patent discloses an ultrasonic generator utilizing a magnetostrictive powder composite operating at a resonance frequency of 23.5 kHz. The Sawyer et al. patent discloses a flow-through reaction tube with three sets of ultrasonic transducers, each set containing four transducers and delivers ultrasound at a frequency of 20 to 40 kHz. These systems are not suitable for high-throughput reactions where a high reaction yield is required.

### SUMMARY OF THE INVENTION

It has now been discovered that ultrasound can be supplied to a reaction system at high energy through a specially designed ultrasonic horn that can withstand the high stress of the vibrations without damage to the horn. Optimally, the horn of this invention is designed for use at a particular ultrasonic frequency, and different horns can be designed and used for different ultrasonic frequencies. The horn is a solid elongate body whose preferred length is approximately equal to a single wavelength of the ultrasonic vibrations through the horn at the selected frequency. The horn has proximal and distal ends, the proximal end adapted to be operatively joined to an ultrasonic transducer and the distal end exposed for immersion in a fluid reaction medium. The distal end is conically shaped to taper at least approximately to a point, thereby enhancing the penetration of the ultrasonic vibrations into the body of the reaction medium. A mounting fixture on the horn located between the proximal and distal ends allows the horn to be mounted to the wall of a reactor vessel with the distal end inside the vessel and the proximal end outside.

The solid elongate body is of unitary construction, which means that it is formed from a single continuous piece of material, rather than from multiple pieces or components that are formed individually and then joined by welding, or by the use of bolts, clamps, or any other method of securing parts together. By “continuous” is meant that the body does not contain internal cavities, but is instead fully dense according to its external dimensions.

The ultrasonic horn of this invention is useful in the performance of any chemical reaction whose yield, reaction rate, or both can be enhanced by ultrasound, and is particularly useful in the desulfurization of crude oil and crude oil fractions. Processes disclosing the use of ultrasound in treating these materials are disclosed in commonly owned U.S. Pat. No. 6,402,939 (issued Jun. 11, 2002), U.S. Pat. No. 6,500,219 (issued Dec. 31, 2002), U.S. Pat. No. 6,652,992 (issued Nov. 25, 2003), U.S. Published Patent Application No. US 2003-0051988 A1 (published Mar. 20, 2003), and U.S. Pat. No. 6,827,844 (issued Dec. 7, 2004). Further disclosures are found in pending U.S. patent application Ser. No. 10/803,802 (filed Mar. 17, 2004), Ser. No. 10/857,444 (filed May 27, 2004), and Ser. No. 10/994,166 (filed Nov. 18, 2004). All patents, patent applications, and publications in general that are cited in this specification are incorporated herein by reference in their entirety for all legal purposes that are capable of being served thereby.

These and other objects, advantages, and features of the invention will be apparent from the description that follows.

### BRIEF DESCRIPTION OF THE DRAWINGS

FIG. 1 is a side view of an ultrasonic horn in accordance with the present invention.

FIG. 2 is an interior view of a reactor and coolant jacket assembly containing both the ultrasonic horn of FIG. 1 and an ultrasonic transducer.

### DETAILED DESCRIPTION OF THE INVENTION AND PREFERRED EMBODIMENTS

As noted above, the length of the ultrasonic horn of this invention is optimally chosen with reference to the wavelength of the ultrasonic vibrations. Thus, once an ultrasonic frequency is selected, the corresponding wavelength of the vibrations in the material from which the horn is manufactured and hence the optimal longitudinal dimension of the horn can be determined. The frequencies known as ultrasonic frequencies are well known and will be readily apparent to those familiar with the use of ultrasound in any of its various applications. In general, ultrasonic vibrations have frequencies within the broad range of from about 15 kHz to about 100 kHz. For the purposes of this invention, a preferred range of ultrasonic frequencies is from about 15 kHz to about 30 kHz, and the most preferred is from about 15 kHz to about 20 kHz. Preferably, the length of the horn is such that the horn operates as a full wavelength resonator for vibrations in the ultrasonic range traveling longitudinally through the horn. Thus, the length of the horn is preferably selected to cause the horn to resonate at the particularly frequency that is selected.

The material of construction of the horn can likewise vary, although for high stress, materials of high strength and toughness are desirable. Metals, and most notably steel, are preferred. A presently preferred class of steels is alloy tool steels, such as the alloy recognized in the steel industry as 2-A tooling steel, which is a fine-grain, air-hardened, steel containing 0.95-1.24% carbon, 4.75-5.50% chromium, 0.90-1.4% molybdenum, 0.15-0.50% vanadium, and a maximum of 1.00% manganese. Steels containing chromium as an alloying element at a concentration of at least about 4% by weight, of which 2-A tooling steel is one, are preferred. The preferred characteristics of the horn may also be expressed as ranges for the length of the horn, and accordingly lengths of from about 20 cm to about 50 cm are preferred, while lengths from about 30 cm to about 35 cm are most preferred. In a presently preferred embodiment, the horn is 2-A tooling steel, the ultrasonic frequency is 17.5 kHz, and the length of the horn is about 31 cm.

The unitary construction of the horn can be achieved by any conventional method of forming steel parts. Examples of these methods are conventional machining and casting. Any method that will not compromise the grain structure or the strength of any portion of the horn can be used. The horn can either be clad with a corrosion-resistant material or left without cladding. Horns that are clad may either be clad in their entirety or clad only on the portions that will extend into the reaction vessel and be in contact with the fluid reaction medium. A further alternative is to clad only the end surface of the portion of the horn that will be immersed in the reaction medium. Examples of cladding materials are silver-based metals, including both silver itself and alloys in which silver is the major component. Alloys in which silver constitutes 85% or more by weight or preferably 90% or more by weight can be used, with alloying components consisting of copper, zinc, cadmium or any combination of two or more of these components. The most preferred horns are those of A-2 tooling steel with no cladding.

Ultrasonic horns of the present invention are elongated bodies with a longitudinal axis, and are preferably bodies of revolution, symmetrically shaped about the longitudinal axis. Regardless of whether the horn is a body of revolution, the cross section of an ultrasonic horn of the present invention in the plane normal to the longitudinal axis varies along the length of the axis. The horn is designed for mounting to a reaction vessel with one end protruding into the vessel interior for immersion in the reaction medium and transmission of the ultrasonic vibrations into the medium, and the other end external to the vessel for operative contact with the source of ultrasonic energy, and specifically for direct coupling with the ultrasonic transducer. For purposes of this specification and the appended claims, the terminus of the horn at the end that is coupled to the ultrasonic transducer is defined as the proximal end while the terminus that extends into the reaction vessel and is exposed to the reaction medium is defined as the distal end. For mounting to the reaction vessel, the horn contains a mounting fixture, such as for example a flange, a shoulder, an extension, bolt holes, and the like, and in preferred embodiments, the mounting fixture is positioned at a distance along the longitudinal axis that is between the proximal and distal ends.

In certain embodiments of this invention, the mounting fixture of the horn will allow the proximal end of the horn and the ultrasonic transducer that is coupled to the proximal end to be surrounded by a coolant jacket. Coolant will be circulated through the jacket in these embodiments to control the temperature rise caused by the ultrasonic energy at the transducer and the proximal end. The horn will also preferably contain o-rings, gaskets, or the like to form seals around the horn at the location where the horn enters the reaction chamber, the coolant jacket, or both.

The cross section variation in preferred embodiments of this invention is generally such that the cross section at the distal end is less than the cross section at the proximal end, thereby increasing the amplitude of the ultrasonic vibrations in the direction leading toward the distal end along at least a portion of the length of the horn, to a maximum amplitude, and most preferably a minimal cross section, at the distal end. This can be achieved by one or more tapering sections in the horn profile. The degree of reduction of the cross section can vary widely, depending on how much amplification is desired and how much vibrational stress the horn will be able to withstand. For best results, percent reductions in the cross section will fall within the range of from about 20% to about 99%, or most preferably from about 40% to about 85%.

The distal end of the horn is conically shaped, and since the horn itself is preferably a body of revolution around the longitudinal axis, the distal end is preferably shaped as a circular cone. The cone angle is not critical and can vary widely; best results in most cases will be achieved with a cone angle, i.e., the angle between the cone axis and the side of the cone, that is within the range of from about 60° to about 87°, or preferably from about 75° to about 85°.

Any of a wide variety of ultrasonic transducers can be used for producing ultrasonic vibrations in the horn. For the high-energy levels of which the horn of this invention is capable, the preferred transducer is a loop-shaped transducer that converts periodically varying voltages to mechanical vibrations in the ultrasound range by way of magnetostriction. The loop is preferably formed as a stack of thin, flat plates of magnetostrictive material laminated together with dielectric material such as a plastic resin or a ceramic adhesive between each pair of adjacent plates. The number of plates in the stack may range from 100 to 400 plates, and the thickness of each plate may range from about 50 microns to about 250 microns.

The size of each plate and hence the loop can vary, although preferably each will have a length ranging from about 5 cm to about 50 cm, with a lesser width, generally ranging from about 3 cm to about 25 cm. The central opening of the loop will typically range from about 0.5 cm to about 5 cm. The transducer loop is wound with a coil of electrically conductive wire, and the windings are arranged and oriented to produce magnetostrictive vibrations in the loop when a varying voltage is imposed across the windings. The windings may for example be coiled in one direction around one lengthwise side of the loop and in the opposite direction around the other lengthwise side.

The transducer can be powered by any oscillating voltage. The oscillations can assume any waveform, ranging for example from a sinusoidal waveform to a rectangular waveform. By “rectangular waveform” is meant a direct current voltage that alternates between a constant positive value and a baseline with stepwise voltage changes in between. The baseline is either a negative voltage or zero voltage, and when the baseline is a negative voltage, the alternating positive and negative voltages are preferably of the same magnitude. Preferred voltage amplitudes are from about 140 volts to about 300 volts, with about 220 volts single-phase most preferred, and preferred wattages are from about 12 kilowatts to about 20 kilowatts. The frequency of the voltage oscillation will be selected to achieve the desired ultrasound frequency. Preferred frequencies are in the range of about 10 to about 30 kilohertz, and most preferably from about 15 to about 20 kilohertz.

When the ultrasound horns of this invention are used in continuous flow-through reactors, the flowing reaction medium will provide cooling of the horn at the distal end. In many cases, as mentioned above, it will also be beneficial to cool the proximal end of the horn and the ultrasound transducer, using a cooling system that is independent of the reaction medium. Cooling of the proximal end of the horn and the ultrasound transducer is conveniently be achieved by enclosing these loops in a jacket or housing through which a coolant is passed or circulated. The jacket resides outside the reaction vessel, and as noted above, the horn is preferably equipped with a secondary mounting fixture so that its proximal end and the transducer can be enclosed in the jacket in a fluid-tight manner. Water is generally an effective and convenient coolant medium for circulation through the jacket.

Ultrasound generators in accordance with this invention can be used in either batch reactors to promote batch-wise reactions or in continuous-flow reactors for reactions performed in a continuous manner. Continuous-flow reactors are preferred.

While this invention is susceptible to a variety of implementations and configurations, a detailed study of specific embodiments will provide the reader with a full understanding of the concepts of the invention and how they can be applied. One such embodiment is shown in the Figures.

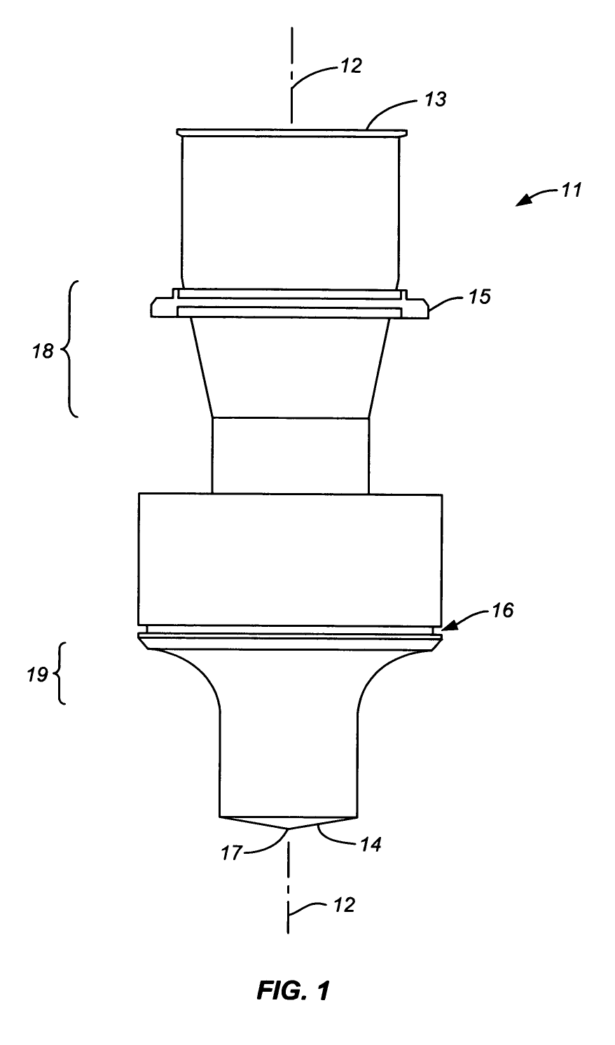

FIG. 1 is an external view of an ultrasonic horn 11 which is a body of revolution about a longitudinal axis 12. The proximal end 13 of the horn is at the top of the figure, and the distal end 14 is at the bottom. A mounting flange 15 for mounting the horn to a reaction vessel is positioned between the proximal and distal ends. A groove 16 encircles the horn at a location near the distal end. The groove is sized to accommodate an o-ring for sealing the periphery of the horn against the internal wall of the reactor, and marks the location of the upper extremity of the reactor cavity. The proximal end 13 of the horn is a flat surface to which the ultrasound transducer (not shown) is mounted, while the distal end 14 is conical in shape, tapering to a point 17. Between the proximal and distal ends, the horn contains two tapering sections, an upper section 18 close to the proximal end 13 and a lower section 19 close to the distal end 14.

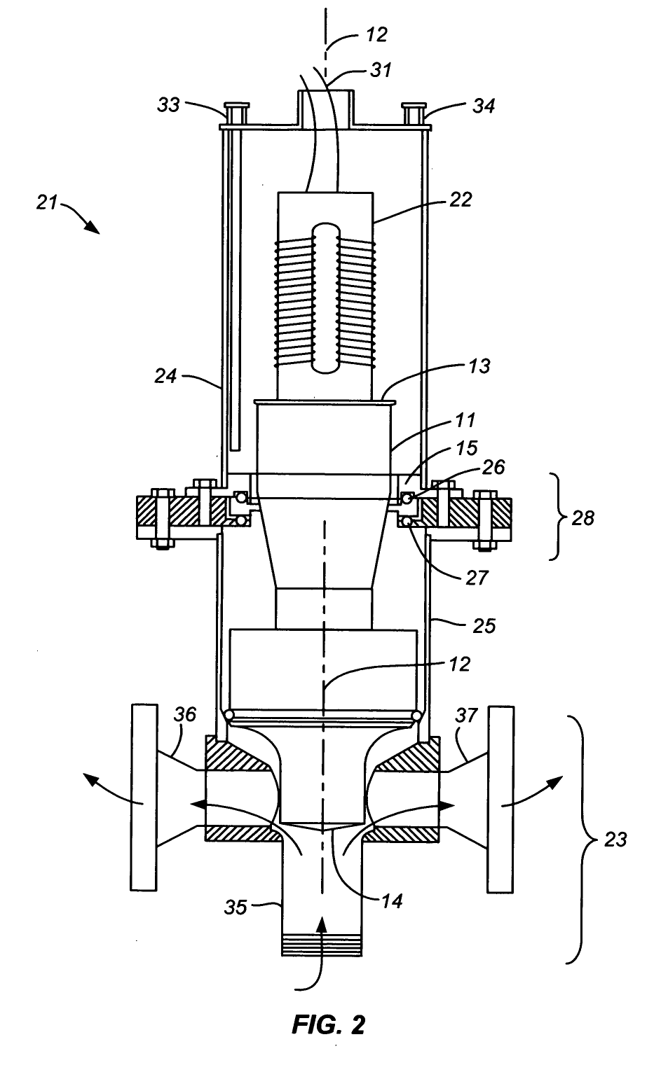

FIG. 2 is a cross section of a reactor and coolant chamber assembly 21 with a horn of the type shown in FIG. 1 and an ultrasound transducer 22 inside the assembly. The assembly 21 includes a continuous flow-through reaction chamber 23, a coolant jacket 24 surrounding the transducer 22 and the proximal end 13 of the ultrasonic horn. A connecting cylinder 25, which is an extension of the reaction chamber 23 and in operation contains neither the reaction medium nor the coolant, joins the reaction chamber 23 to the coolant jacket 24. The coolant jacket 24 is closed at the bottom by the mounting flange 15 and sealed with o-rings 26, 27 at the flange 15. The coolant jacket 24, the reaction chamber extension 23, and the horn 11 are secured together by an arrangement of flanges and bolts 28 at the level of the mounting flange 15 of the horn.

The ultrasound transducer 22 is a loop-shaped electromagnet wound with coils of electrical wire that are insulated both thermally and electrically. Electric leads 31 to the coils pass outside the jacket through a sealed port 32 and are connected to an external power supply, amplifier and controller (not shown). A coolant inlet 33 directs coolant to the jacket interior and the heated coolant leaves through a coolant outlet 34.

The reaction medium that is treated with ultrasound enters the reaction chamber 23 through an inlet port 35 which is coaxial with the longitudinal axis 12 of the horn, and leaves the reactor through exit ports 36, 37 laterally positioned on the sides of the reaction chamber. The distal end 14 of the ultrasonic horn is positioned directly in the mouth of the inlet port 35 so that the incoming reaction medium strikes the distal end 14, flows radially outward over the surface of the distal end 14 and leaves through the exit ports 36, 37.

The power components, including the power supply, the amplifier, and the controller, are conventional components available from commercial suppliers and readily adaptable to perform the functions described above. A computer-controlled arbitrary waveform generator such as the Agilent 33220A or Advantek 712 with an output DAC (digital-to-analog converter) or a microprocessor-drive, voltage-controlled waveform generator designed from an 8038 integrated circuit chip can be used. The arbitrary waveform generator can be auto-tuned by an output DAC on a microprocessor or by functions in a LabVIEW® (National Instruments Corporation, Austin, Tex., USA) computer, in which pulse software controls the arbitrary waveform generator to maximize the ultrasonic output by adjusting the pulse frequency to the transducer resonance frequency. The positive and negative pulse components can also be adjusted to give an overall DC component that will maximize the magnetostrictive effect.

Integrated gate bipolar transistors in a full bridge power configuration can be used as power components. One such configuration is a full bridge power configuration using four integrated gate bipolar transistors (IGBTs) formed in a configuration of two half-bridge push-pull amplifiers. Each half bridge section is driven by an asymmetrical rectangular pulse train, the trains being 180 degrees out of phase. The relative amounts of the positive and negative pulse components that drive each half bridge section can be optimized for maximum ultrasound output power. Each IGBT is isolated from the signal source by an opto-isolation driving transistor.

The foregoing is offered primarily for purposes of illustration. Further variations in the components of the apparatus and system, their arrangement, the materials used, the operating conditions, and other features disclosed herein that are still within the scope of the invention will be readily apparent to those skilled in the art.

What is claimed is:

1. An ultrasonic horn comprising
a solid elongate body having a longitudinal axis, one end of said longitudinal axis defined as a proximal end and the other as a distal end,
said elongate body being a unitary piece of material capable of ultrasonic vibration, the length of said elongate body being approximately equal to the wavelength of ultrasonic waves through said material at a selected ultrasonic frequency,
said elongate body being conically shaped at said distal end, and having a mounting surface at said proximal end for an ultrasound transducer and a mounting fixture between said proximal and distal ends for mounting said elongate body to a flow-through reactor such that said distal end extends into the interior of said flow-through reactor.

2. The ultrasonic horn of claim 1 wherein said material is an alloy tool steel.

3. The ultrasonic horn of claim 1 wherein said material is an alloy tool steel containing at least about 4% chromium.

4. The ultrasonic horn of claim 1 wherein said material is steel and said length is from about 20 cm to about 50 cm.

5. The ultrasonic horn of claim 1 wherein said material is an alloy tool steel containing at least about 4% chromium and said length is from about 20 cm to about 50 cm.

6. The ultrasonic horn of claim 1 wherein said elongate body has a profile comprising a tapering section between said proximal end and said distal end.

7. The ultrasonic horn of claim 1 further comprising sealing means between said mounting flange and said distal end for sealing said horn against an interior wall surface of a reactor.

8. A continuous flow-through reactor comprising:
a reaction vessel having a longitudinal axis and inlet and outlet ports, said inlet port arranged to direct an inflowing reaction mixture along said longitudinal axis, and
an ultrasonic horn comprising a solid elongate body having a longitudinal axis, one end of said longitudinal axis defined as a proximal end and the other as a distal end, said elongate body being a unitary piece of material capable of ultrasonic vibration, the length of said elongate body being approximately equal to the wavelength of ultrasonic waves through said material at a selected ultrasonic frequency, said elongate body being conically shaped at said distal end, and having a mounting surface at said proximal end for an ultrasound transducer and a mounting fixture between said proximal and distal ends for mounting said elongate body to said reaction vessel such that said distal end extends into the interior of said reaction vessel.

9. The continuous-flow reactor of claim 8 wherein said horn material is an alloy tool steel.

10. The continuous-flow reactor of claim 8 wherein said horn material is an alloy tool steel containing at least about 4% chromium.

11. The continuous-flow reactor of claim 8 wherein said horn material is steel and said length is from about 20 cm to about 50 cm.

12. The continuous-flow reactor of claim 8 wherein said horn material is an alloy tool steel containing at least about 4% chromium and said length is from about 20 cm to about 50 cm.
